(19) United States
(12) Patent Application Publication
(10) Pub. No.: US 2005/0152830 A1
(43) Pub. Date: Jul. 14, 2005

(54) Manufacturing process of Li-contained nickel oxyhydroxide and nonaqueous electrolyte electrochemical cells with it

(75) Inventors: Miki Yasutomi, Kyoto-shi (JP); Toru Tabuchi, Kyoto-shi (JP); Yoshihiro Imai, Osaka-shi (JP); Yoshiji Matsuda, Osaka-shi (JP)

Correspondence Address: SUGHRUE MION, PLLC, 2100 PENNSYLVANIA AVENUE, N.W., SUITE 800, WASHINGTON, DC, 20037, US

(73) Assignees: JAPAN STORAGE BATTERY CO., LTD.; THE KANSAI ELECTRIC POWER CO., LTD.

(21) Appl. No.: 10/959,068

(22) Filed: Oct. 7, 2004

(30) Foreign Application Priority Data
Oct. 10, 2003 (JP) P. 2003-351608

(51) Int. Cl. C01G 53/04

(52) U.S. Cl. 423/594.4

(57) ABSTRACT

The present invention is concerned on the manufacturing process of Li-contained nickel oxyhydroxide obtained by a lithium absorption process with contact reaction between nickel oxyhydroxide and a solution obtained by dissolving metallic Li and polycyclic aromatic compounds in a solvent. Moreover, the nonaqueous electrolyte electrochemical cell using Li-contained nickel oxyhydroxide active material obtained by this manufacturing process is able to be high performance with a low manufacturing price by its simple process compared to the existing process by electrochemical process and so on.

### TECHNICAL FIELD

The present invention relates to a manufacturing process of Li-contained nickel oxyhydroxide and the nonaqueous electrolyte electrochemical cells with it.

### BACKGROUND OF ART

In recent years, the small and lightweight Li-ion cells have widely used as a power supply for electronic devices such as cellular phone and digital camera. As such electronic devices have been remarkably progressed for their multi-functionalization, the appearance of the Li-ion cells with much higher energy density will be expected for the replacement of currently used LiCoO₂/C, LiNiO₂/C, and LiMn₂O₄/C system lithium ion cells. For the purpose, positive and negative active materials with large capacity need to be developed.

Nickel oxyhydroxide among various compounds has been investigated for the use of positive active material of this nonaqueous electrolyte rechargeable cell, since the discharge capacity per unit weight is large and charge-discharge cycle performance is excellent.

However, lithium contributed to the redox reaction is not contained in the charged-state of nickel oxyhydroxide. And then, the use of metallic Li and Li alloy as the negative active materials containing lithium source with a combination of this material was considered, but these negative materials were not able to be used since the reversibility was poor. Even in the case of using a carbon material as its negative active material, lithium has to be contained into carbon material in advance.

To manufacture the lithium contained carbon material LiₓC (X>0), there needs the electrochemical method that the cathodic current (charging) reported in the Japanese published unexamined patent 2002-075454 is to be passed by using the suitable counter electrode such a metallic lithium in the electrolyte containing Li⁺ ion. An electrode with carbon material has to be first prepared and then the current has to be passed for this method. Therefore, the attachment process of a current lead is complicated and the manufacturing cost becomes to be higher, because direct current power supply and current control equipment are also required.

The LiₓC (X>0) is remarkably unstable against water and air as well as the case of metallic Li powder and there is also a problem in handling. Moreover, the method for attaching with metallic Li on carbon material reported in the Japanese published unexamined patent Hei05-159770 has a problem of complicated process.

On the other hand, if no Li contained carbon material is to be used as a negative active material, the electrochemical method or attachment of metallic Li to electrode becomes no necessary. However, in the case of no Li contained carbon as negative active material, nickel oxyhydroxide as positive active material has to be prepared as the Li contained material. To manufacture the lithium contained nickel oxyhydroxide (discharged state of nickel oxyhydroxide), there needs the electrochemical method that the cathodic current (discharging) is to be passed by using the suitable counter electrode such a metallic lithium in the electrolyte containing Li⁺ ion. However, there are some problems that attachment process of a lead is complicated and its manufacturing cost becomes to be higher, because direct current power supply and current control equipment are also required as well as the case of electrochemical manufacturing process for LiₓC (X>0).

In addition, the Japanese published unexamined patent Hei05-135760 reported on a process for the synthesis for LiₓCoO₂ (x>1) and LiₓNiO₂ (x>1) by immersion of Li-contained material such as LiCoO₂ and LiNiO₂ into the solution containing butyl lithium, phenyl lithium, naphthyl lithium, or iodide lithium etc. Furthermore, the Japanese patent No. 3227771 proposed the method for compensating the lithium content consumed as irreversible capacity of positive electrode by immersion Li-contained material into solution dissolving Li⁺ ion and polycyclic aromatic compounds. However, there was no description whether this method is to be applied to charged-state non-lithium-containing nickel oxyhydroxide or not, and it was unknown on the effect. In addition, Japanese published unexamined patent 2000-95525 reported on a process for the synthesis of Li-contained nickel oxyhydroxide by reaction with lithium compounds which has reduction to nickel oxyhydroxide and/or the derivatives, for example in the organic solvent including n-butyl lithium. However, these methods still have problems of safety on handling and so on, because of its extremely higher reactivity.

### SUMMARY OF THE INVENTION

The objective of the present invention is to offer a manufacturing process of Li-contained nickel oxyhydroxide (discharged-state of nickel oxyhydroxide) without the conventional electrochemical method for the synthesis of Li-contained nickel oxyhydroxide, attachment of metallic Li, and the use of lithium compound with high reactivity, and the nonaqueous electrolyte electrochemical cells such as battery and capacitor etc. with it obtained by this manufacturing process.

The fist invention is a manufacturing process of Li-contained nickel oxyhydroxide characterized by a lithium absorption process with contact between nickel oxyhydroxide and solution obtained by dissolving metallic Li and polycyclic aromatic compound in a solvent.

The second invention is a manufacturing process of Li-contained nickel oxyhydroxide according to first invention, wherein the amount of lithium absorption x is in the range of 0.5≦x≦2 mol to the 1 mol of nickel oxyhydroxide.

The third invention is a manufacturing process of Li-contained nickel oxyhydroxide according to first invention, wherein the half width of the peak appeared at around 2 θ=18.8±0.5° of X-ray diffraction patterns obtained by the measurement of the Li-contained nickel oxyhydroxide using CuKα radiation is equal to or more than 1.0°.

The fourth invention is a manufacturing process of Li-contained nickel oxyhydroxide according to first invention, wherein a part of nickel of Li-contained nickel oxyhydroxide is replaced by cobalt, and the content of cobalt is in the range from 0.2 to 24 mol % to the total mole concentration of nickel and cobalt in the Li-contained nickel oxyhydroxide.

The fifth invention is a manufacturing process of Li-contained nickel oxyhydroxide according to first invention, wherein the polycyclic aromatic compound is at least one sort selected from naphthalene, phenanthrene, and anthracene.

The sixth invention is a manufacturing process of nonaqueous electrolyte electrochemical cell characterized by using an electrode with the Li-contained nickel oxyhydroxide obtained by the process according to the first invention.

The seventh invention is a manufacturing process of the nonaqueous electrolyte electrochemical cell using an electrode with the Li-contained nickel oxyhydroxide obtained by the process according to the second invention.

The eighth invention is a manufacturing process of the nonaqueous electrolyte electrochemical cell using an electrode with the Li-contained nickel oxyhydroxide obtained by the process according to the third invention.

The ninth invention is a manufacturing process of the nonaqueous electrolyte electrochemical cell using an electrode with the Li-contained nickel oxyhydroxide obtained by the process according to the fourth invention.

The tenth invention is a manufacturing process of the nonaqueous electrolyte electrochemical cell using an electrode with the Li-contained nickel oxyhydroxide obtained by the process according to the fifth invention.

### EXPLANATION OF FIGURES

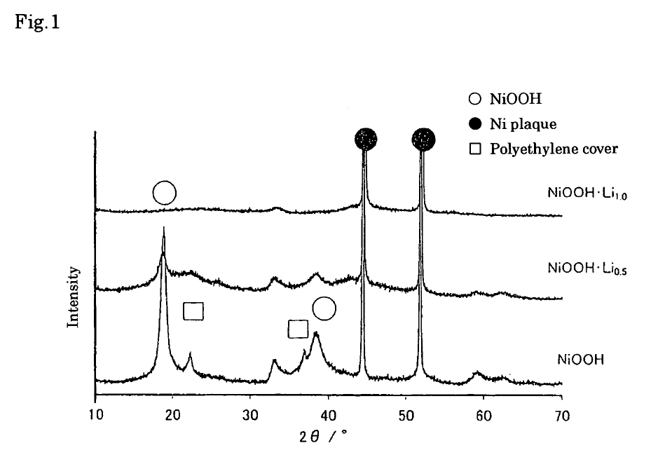

XRD patterns for NiOOH.Li_{0.5}, NiOOH.Li_{1.0}, and NiOOH are shown in FIG. 1.

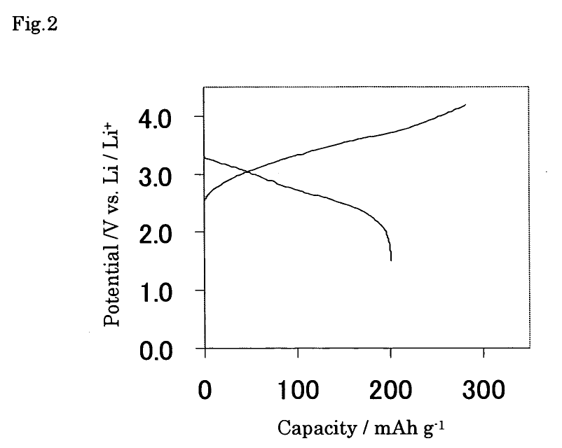

The electrochemical potential behavior of the Li-contained nickel oxyhydroxide electrode for Example 1 is shown in FIG. 2.

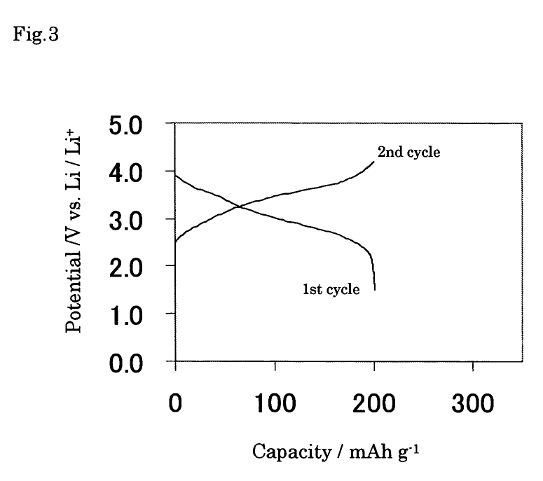

The electrochemical potential behavior of the nickel oxyhydroxide electrode for Comparative example 1 is shown in FIG. 3.

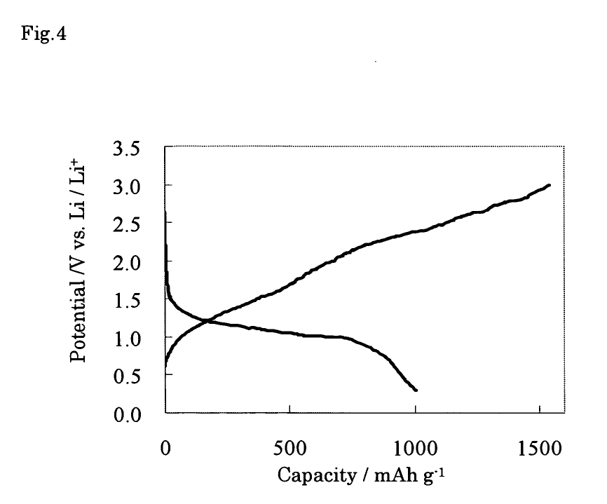

The electrochemical characteristic of the electrode for Example 6 is shown in FIG. 4.

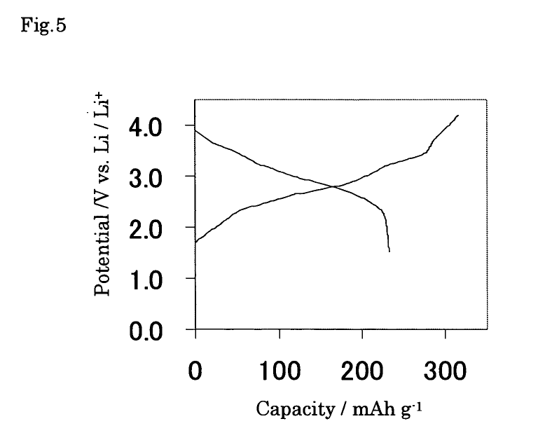

The electrochemical characteristic of the electrode for Example 17 is shown in FIG. 5.

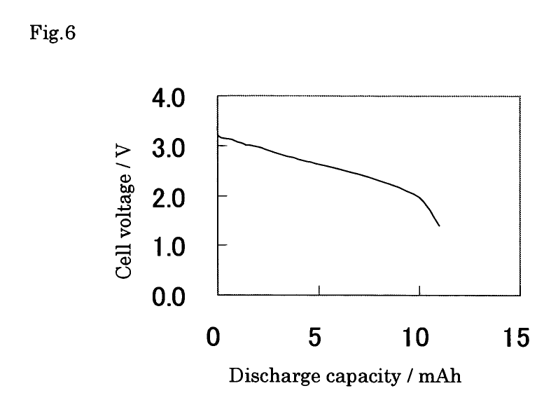

The characteristic of the nonaqueous electrolyte cell for Example 21 is shown in FIG. 6.

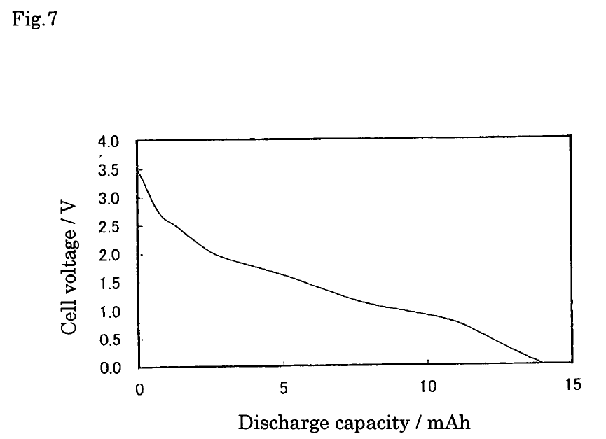

The characteristic of the nonaqueous electrolyte cell for Example 22 is shown in FIG. 7.

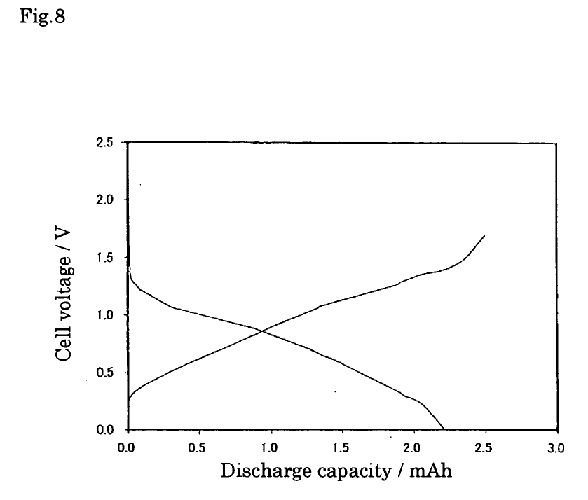

The characteristic of the capacitor for Example 23 is shown in FIG. 8.

### DETAILED DESCRIPTION OF THE INVENTION

The manufacturing process of the Li-contained nickel oxyhydroxide of the present invention is to absorb lithium to nickel oxyhydroxide by contact between nickel oxyhydroxide and the solution obtained by dissolving metallic Li and polycyclic aromatic compounds in a solvent, hereinafter the solution is expressed by “solution S”. Furthermore, nonaqueous electrolyte electrochemical cells such as battery and capacitor etc. are to be prepared with the electrode containing Li-contained nickel oxyhydroxide obtained by the manufacturing process according to the present invention. Naphthalene, anthracene, phenanthrene, methylnapthnalene, ethylnaphthalene, naphthacene, pentacene, pyrene, picene, triphenylene, anthanthrene, acenaphthene, acenaphthylene, benzopyrene, benzofluorene, benzophenanthrene, benzofluoroanicene, benzoperylene, coronene, chrysene, hexabenzoperylene and their derivatives are mentioned as polycyclic aromatic compounds of the present invention.

The NiOOH according to the present invention includes the material of Ni₁₋ₐMₐOOH (0<a≦0.5, wherein M is at least one sort selected from Co, Ti, V, Cr, Mn, Fe, Cu, and Zn) for the replacement of a part of nickel of nickel oxyhydroxide at least one sort of selected from Co, Ti, V, Cr, Mn, Fe, Cu, and Zn. Especially, charge-discharge cycle performance is greatly improved by the substitution of cobalt for a part of nickel. The content of cobalt is preferable in the range from 0.2 to 24 mol % to the total mole concentration of nickel and cobalt. The reason is that the crystalline becomes stable by the formation of solid solution between nickel and cobalt in this range. These nickel oxyhydroxides are to be synthesized by a conventional well-known method such as oxidation of nickel hydroxide by using sodium hypochlorite.

Li-contained nickel oxyhydroxide of the present inventions is to be obtained by contact between the solution S and nickel oxyhydroxide, which are for examples immersion nickel oxyhydroxide into the solution S after the preparation or sprinkling the solution S on nickel oxyhydroxide etc. Moreover, Li-contained nickel oxyhydroxide of the present inventions is to be obtained by contact between the solution S and electrode contained nickel oxyhydroxide (hereinafter the electrode is expressed “electrode D”), which are for examples immersion the electrode D into the solution S after preparation of the electrode D or sprinkling the solution S on the electrode D etc. Thus, either cases are to be applied that the electrode is prepared after contacting nickel oxyhydroxide and the solution S, or the electrode D and the solution S are contacted after preparing the electrode D. In addition, either case is to be applied that metallic Li and polycyclic aromatic compounds are dissolved in solvent after contacting between nickel oxyhydroxide and the solvent, or nickel oxyhydroxide and the solution are contacted after dissolving metallic Li and polycyclic aromatic compounds in solvent. In the case that the electrode D is firstly prepared, either cases are to be applied that metallic Li and polycyclic aromatic compounds are dissolved in solvent after contacting between the electrode D and the solvent, or the electrode D and the solution are contacted after dissolving metallic Li and polycyclic aromatic compounds in solvent.

When metallic Li and polycyclic aromatic compounds are dissolved in organic solvent, an electron moves from metallic Li to polycyclic aromatic compounds so that the complex solution is produced by the formation of the anion and Li⁺ ion. Therefore, in the case of dissolving fully metallic Li in this complex solution S, Li⁺ ion, polycyclic aromatic compounds, anion of polycyclic aromatic compounds, and solvent are existed in the solution. In the case of dissolving partly metallic Li, metallic Li, Li⁺ ion, polycyclic aromatic compounds, anion of polycyclic aromatic compounds, and solvent are existed in the solution. Then, Li⁺ ion is immediately absorbed to nickel oxyhydroxide just at the same time of movement of electron from the anion of polycyclic aromatic compounds to nickel oxyhydroxide. Aromatic compounds have a function of the role of catalyst in this lithium-absorption reaction, since anion of polycyclic aromatic compounds return to polycyclic aromatic compounds.

The concentration of lithium in the solution S is preferable in the range from 0.07 g dm⁻³ to its saturation. If the concentration is lower than 0.07 g dm⁻³, there appears the problem that absorption time becomes long. Lithium-saturated concentration is therefore more preferable to shorten the absorption time. The concentration of the polycyclic aromatic compounds in the solution S is preferable in the range from 0.005 to 2.0 mol dm⁻³. It is more preferable from 0.005 to 0.25 mol dm⁻³, and still more preferable from 0.005 to 0.01 mol dm⁻³. If the concentration of polycyclic aromatic compounds is lower than 0.005 mol dm⁻³, there also appears the problem that the absorption time becomes long, and further if the concentration is higher than 2.0 mol dm⁻³, there appears the problem that polycyclic aromatic compounds is precipitated in the solution.

The contact reaction time between the solution S and nickel oxyhydroxide is not especially restricted, but preferably at least more than 0.1 hours for the fully absorption of lithium into nickel oxyhydroxide, more preferably in the range of 0.1 to 240 hours, and still more preferable from 0.1 to 72 hours. Lithium-absorption rate is to be accelerated by stirring the solution in the case of the contacting solution S and nickel oxyhydroxide. Moreover, if the temperature of solution S becomes high, lithium-absorption rate is to be accelerated, but the temperature is preferable to be controlled below the boiling point of its solvent for solution S for the purpose of preventing of boiling of the solution, more preferably in the range from 25 to 60° C. from the viewpoint of environmental aspect for worker.

Diethyl ether, 1-methoxypropane, 1-methoxybutane, 2-methoxybutane, 1-methoxypenthane, 2-methoxypenthane, 1-methoxyhexane, 2-methoxyhexane, 3-methoxyhexane, 1-ethoxypropane, 2-ethoxybutane, tetrahydrofuran, 2-methyltetrahydrofuran, 1,2-dimethyltetrahydrofuran, and dimethyl sulfoxide, etc. are mentioned as solvent used for the solution S in the present invention.

Thus, a sort of solvent used for the solution S is not especially restricted. The produced material by decomposition of solvent adheres on the surface of nickel oxyhydroxide or its material reacts with nickel oxyhydroxide resulting in the appearance of problem that lithium-absorption rate becomes small inside portion of nickel oxyhydroxide. Therefore, a solvent of chain monoether, which is hard to decompose, is preferable as the solvent for solution S.

Li-contained nickel oxyhydroxide according to the present invention is composed of x mol lithium absorbed to 1 mol of nickel oxyhydroxide, and the value of x is to be selected arbitrarily by the control of concentration of Li⁺ ion and polycyclic aromatic compounds in solution S, stirring time, reaction time, temperature, and so on. In the present invention, x is the mole number of lithium to 1 mol of nickel oxyhydroxide. The mole number of lithium is to be determined by the calculation of amount of electricity obtained from the charging test of electrode with Li-contained nickel oxyhydroxide active material wherein the amount of electricity obtained from the charging test is the amount of electricity for anodic current to be passed by using this test electrode as a working electrode, metallic Li as counter and reference electrodes, and the mixture electrolyte of 1 mol dm⁻³ LiClO₄ dissolving ethylene carbonate (EC) and ethyl methyl carbonate (EMC) (1:1 in the volume ratio) at the constant current of 0.01 C mA (C is based on the theoretical capacity of one electron reaction of nickel oxyhydroxide) to 4.2 V vs. Li/Li⁺ at 25° C.

In the case of conventional method, where nickel oxyhydroxide reacts in the hexane or ethyl alcohol solution including n-butyl lithium as reducing agent, there are some problems that lithium nickel oxide is produced immediately by significantly rapid reaction accompanied with the extraction of H from nickel oxyhydroxide resulting in the collapse of its crystal structure. However, the method of contact reaction between nickel-oxyhydroxide and solution S according to the present invention is no necessary to remove the side reaction product such as lithium nickel oxide and so on, on account of the formation of Li-contained nickel oxyhydroxide as an objective product, since polycyclic aromatic compounds works as catalyst resulting no extraction reaction of H from nickel oxyhydroxide.

In a manufacturing process of Li-contained nickel oxyhydroxide according to the present invention, where x mol lithium is inserted into 1 mol of nickel oxyhydroxide, x is preferable in the range of 0.5≦x≦2. The reason is that the cycle performance is found to be better in this range.

Furthermore, the crystal structure of Li-contained nickel oxyhydroxide according to the present inventions is preferable to be amorphous. When the value of x was 0.5 or more in Li-contained nickel oxyhydroxide identified by x mol lithium inserted into 1 mol of nickel oxyhydroxide, the amorphouszation of its crystalline structure was turned out to be occurred.

Wherein the amorphous is defined that the half width of a peak for Li-contained nickel oxyhydroxide appeared at around 18.8±0.5° analyzed by XRD analysis using CuK α is 1.0° or more. The XRD pattern of Li-contained nickel oxyhydroxide obtained by the manufacturing process according to the present invention is shown in FIG. 1. The mark ◯ shows the peak of NiOOH, the mark ● shows the peak of nickel plaque, and the mark □ shows the peak of polyethylene covered-sheet. It is turned out that Li-contained nickel oxyhydroxide with x value of 0.5 shows the amorphouszation of crystalline structure with the half width value of 1.0° or more. Furthermore, it was turned out that the side reaction product was not produced by the manufacturing process according to the present invention, since no other peaks except NiOOH, nickel plaque, and a polyethylene covered sheet were seen in FIG. 1.

The electrode including Li-contained nickel oxyhydroxide is to be used for the positive electrode side, negative electrode side, or both positive and negative electrode in the case that nonaqueous electrolyte electrochemical cell is nonaqueous electrolyte secondary cells.

In the case of using the Li-contained nickel oxyhydroxide for positive electrode of the nonaqueous electrolyte electrochemical cell, there is no restriction for negative active material, which is selected from various materials for example, carbon material of graphite or amorphous carbon, oxide, and nitride. Among these materials, carbon such as graphite, amorphous carbon etc, and oxide are preferable because their capacity or charge-discharge cycle performance are excellent.

In the case of using the Li-contained nickel oxyhydroxide for negative electrode of the nonaqueous electrolyte electrochemical cell, there is no restriction for positive active material, which material is selected from various materials for example, transition metal oxide of manganese dioxide, or vanadium pentoxide, transition metal chalcogen of ferric sulfide or titanium sulfide, and carbon material such as graphite or active carbon, and so on.

In the case of using the Li-contained nickel oxyhydroxide for the nonaqueous electrolyte electrochemical cell, it is defined as nonaqueous electrolyte secondary cell or capacitor if the material is different between positive and negative electrode and as a capacitor if the material is the same one in positive and negative electrodes.

The materials used for a conventional nonaqueous electrolyte secondary batteries as a binder is to be used for the electrodes from styrene-butadiene rubber (SBR), carboxymethylcellulose (CMC), and so on.

As a solvent or solution used for mixing a binder, the solvent or solution that dissolves or disperses the binder is to be used. Nonaqueous and aqueous solvents such as N-methyl-2-pyrrolidone (NMP) is to be used as the solvent or solution, and the aqueous solution is to be used with adding of dispersion or rheology control agent etc.

As a current collector for the electrodes, iron, copper, stainless steel, nickel, and aluminum is to be used. Wherein the shape of the current collector is foam, porous, expanded grid, and so on. Furthermore, these current collectors are to be made a hole into arbitrary form.

As an organic solvent for electrolyte, ethylene carbonate, propylene carbonate, dimethyl carbonate, diethyl carbonate, and ethyl methyl carbonate, and so on are to be used with one or a mixture thereof.

Moreover, the compounds including carbonate systems such as vinylene carbonate, butylene carbonate, and so on, benzene systems such as biphenyl, cyclohexylbenzene, and so on, and sulfide systems such as propanesultone, and so on are to be used as the additive of one or a mixture thereof into the electrolyte.

Furthermore, solid electrolyte is to be used. As a solid electrolyte, an inorganic solid electrolyte and polymer solid electrolyte are to be used.

As a lithium salt dissolved in the organic solvent, LiPF₆, LiClO₄, and LiBF₄ used for conventional nonaqueous electrolyte cells are to be used with one or a mixture thereof. LiPF₆ is preferable because of good cycle performance.

As the separator, a cloth, bonded fabric, and micro porous membrane are to be used. Especially, the polyolefin micro porous membrane such as a polypropylen, polyethylene is preferable. Furthermore, solid electrolyte such as polymer solid electrolyte also is used as a separator. In this case, polymer solid electrolyte using porous polymer electrolyte membrane is to have organic electrolyte.

The figuration of the nonaqueous electrolyte electrochemical cells is to be used as a various types of prismatic, elliptical, coin, button, sheet, etc. in the present inventions.

### EXAMPLES

The preferable examples according to the present invention are described as follows.

### Example 1, Comparative Example 1, and Comparative example 2

### Example 1

First, nickel oxyhydroxide (NiOOH) powder with average particle diameter of 10 μm was prepared by oxidation reaction of nickel hydroxide with sodium hypochlorite. The solution S1 was then prepared by dissolving 0.25 mol dm⁻¹ naphthalene and saturated metallic Li in diethyl ether as a solvent.

The Li-contained nickel oxyhydroxide according to the present invention was obtained by immersion of nickel oxyhydroxide powder with the average particle diameter of 10 μm in the solution S1, leaving at rest for 24 hours at 25° C., washing by dimethyl carbonate after filtration, and drying at 50° C. under vacuum.

The paste was prepared by mixing this powder active material 80 mass %, acetylene black 5 mass %, and PVDF 15 mass % dissolved in N-methyl-2-pyrrolidone (NMP). The electrode of the Example 1 according to the present invention was prepared by the process that this paste was then coated on foamed nickel substrate with the porosity of 85% and 10 mm W×20 mm L×150 μm T, and dried at 70° C. under vacuum for the evaporation of NMP.

The glass cell with 3 electrodes was prepared by using the obtained electrode of Example 1 as working electrode, metallic Li as counter and reference electrodes, and the mixture electrolyte of 1 mol dm⁻³ LiClO₄ containing ethylene carbonate (EC) and ethyl methyl carbonate (EMC) (1:1 in the volume ratio). The electrochemical behavior for electrode of Example 1 was measured with by passing a cathodic curren at the constant current of 0.01 C mA to 1.5 V vs. Li/Li⁺ after passing anodic current at the constant current of 0.01 C mA to 4.2 V vs. Li/Li⁺ at 25° C. The result is shown in FIG. 2.

The potential of the electrode is shifted toward more noble potential gradually from 2.5 V vs. Li/Li⁺ to 4.2 V vs. Li/Li⁺ by passing anodic current as shown in FIG. 2. The amount of electricity was 282 mAh g⁻¹ per mass unit of Li-contained nickel oxyhydroxide. Moreover, the potential of the electrode is shifted toward less noble potential gradually from 4.2 V vs. Li/Li⁺ to 1.5 V vs. Li/Li⁺ by passing cathodic current at same current. The amount of electricity was 201 mAh g⁻¹ per mass unit of the Li-contained nickel oxyhydroxide.

### Comparative Example 1

The electrode of Comparative example 1 was prepared in the same manner as Example 1 except that the nickel oxyhydroxide powder of Example 1 was used without immersion into the solution S1. Furthermore, The electrochemical behavior for electrode of Comparative example 1 was measured in the same manner as Example 1. The result is shown in FIG. 3. The amount of electricity charged for the electrode of Comparative example 1 was 0 mAh g⁻¹ per mass unit of Li-contained nickel oxyhydroxide by passing anodic current to 4.2 V vs. Li/Li⁺ at 0.01 C mA at 25° C. After that the potential of the electrode of Comparative example 1 was shifted toward less noble potential gradually from 3.7 V vs. Li/Li⁺ to 1.5 V vs. Li/Li⁺ by passing cathodic current at the same current. The amount of electricity was 201 mAh g⁻¹ per mass unit of the Li-contained nickel oxyhydroxide. Then the amount of electricity charged was 199 mAh g⁻¹ per mass unit of Li-contained nickel oxyhydroxide by passing anodic current to 4.2 V vs. Li/Li⁺ again.

The charge behavior of the electrode of Comparative example 1 was not observed by passing anodic current to 4.2 V vs. Li/Li⁺, while the electricity charged to 4.2 V vs. Li/Li⁺ was obtained on the electrode of Example 1 including the Li-contained nickel oxyhydroxide of Example 1 in FIG. 2. This reason is that the electrode of Example 1 was included lithium resulting form immersion in the solution S1, so that it became possible to extract from nickel oxyhydroxide electrochemically by charging, although the electrode of Comparative example 1 does not contain lithium.

Here, the important knowledge was found out Namely, Li-contained nickel oxyhydroxide was synthesized by not electrochemical method, but chemical method of contact reaction between conventional well-known nickel oxyhydroxide as positive active material used for lithium battery and the solution dissolving metallic Li and polycyclic aromatic compounds.

Moreover, the amount of anodic current electricity of 282 mAh g⁻¹ per mass unit of Li-contained nickel oxyhydroxide means that x of general equation shown as NiOOH.Liₓ is approximately 1.

### Comparative Example 2

The electrode of Comparative example 2 was prepared in the same manner as Example 1 except that the solution S1′ obtained by dissolving 1.6 mol dm⁻³ n-butyl lithium in diethyl ether was used instead of the solution S1. Furthermore, the electrochemical potential behavior for electrode of Comparative example 2 was measured in the same manner as Example 1. The first electricity charged and discharge capacity are shown in Table 1 with results of Example 1. Where, electricity charge and discharge capacity show the amount of electricity per mass unit of nickel oxyhydroxide.

TABLE 1

| | Electricity charged | Discharge capacity |
|---|---|---|
| | at 1st cycle | at 1st cycle |
| | mAh g⁻¹ | mAh g⁻¹ |
| Example 1 | 282 | 201 |
| Comparative example 2 | 72 | 80 |

The following fact has been cleared from the result in table 1. Namely, the electricity charged and discharge capacity per mass unit of obtained powder of the electrode of Comparative example 2 became smaller because the electrode of Comparative example 2 included not only Li-contained nickel-oxyhydroxide, but also various nickel oxides as an impurity. The reason seems to be that lithium nickel oxide was produced in the case of the reaction in the hexane or ethyl alcohol solution including n-butyl lithium as reducing agent, as a result of vigorously rapid reaction with extraction of H from nickel oxyhydroxide resulting in the collapse of its crystal structure.

In addition, the mixture containing Li-contained nickel oxyhydroxide and lithium nickel oxide was produced similarly in the case of using s-butyl lithium, t-butyl lithium, phenyl lithium, naphthyl lithium, iodide lithium, or boron hydride lithium instead of n-butyl lithium of the Comparative example 2 for the solution S1′.

### Example 2˜5

The x value of Li-contained nickel oxyhydroxide shown as general equation NiOOH.Liₓ was changed by the different immersion time of nickel oxyhydroxide in the solution S1 by using the same nickel oxyhydroxide and solution S1 as in the case of Example 1. After the electrode was prepared by the same manner of Example 1, the charge and discharge tests of the electrode were conducted at the constant current of 0.01 C mA in the potential range from 1.5 V to 4.2 V vs. Li/Li⁺ at 25° C. for 50 cycles. Discharge capacity retention (%) is defined as the rate of discharge capacity at 50th cycle to discharge capacity at 1st cycle. The measurement results are shown in Table 2.

TABLE 2

| | The value of x in | Electricity | Discharge | |
|---|---|---|---|---|
| | Li-contained | charged | capacity | Discharge |
| | nickel | at 1st cycle | at 1st cycle | capacity |
| | oxyhydroxide | mAh g⁻¹ | mAh g⁻¹ | retention % |
| Example 2 | 0.30 | 88 | 199 | 78 |
| Example 3 | 0.50 | 146 | 200 | 91 |
| Example 1 | 0.97 | 282 | 201 | 93 |
| Example 4 | 2.00 | 584 | 552 | 92 |
| Example 5 | 2.20 | 642 | 589 | 73 |

The following fact has been cleared from the results in table 2. That is, in the all case of Example 1 to 5, The charge-discharge test was to be carried out From the facts, Li-contained nickel oxyhydroxide was found to be obtained by the method of Example 1 to 5. In the case that the x value of Li-contained nickel oxyhydroxide shown as general equation NiOOH.Liₓ was 0.5≦x≦2.0, it was found that its charge-discharge cycle performance was excellent because discharge capacity retention was more than 90%. In the case that the value of x was 0.5 or more, it was turned out that the half width of a peak for Li-contained nickel oxyhydroxide appeared at around 18.8±0.5° analyzed by XRD using CuKα is 1.0° or more, amorphouszation was proceeded (in FIG. 1).

### Example 6

The electrode of Example 6 was prepared by using the same nickel oxyhydroxide and solution S1 as the case of Example 1 except the stirring in the solution S1 for 24 hours, and then charge and discharge tests were conducted at the constant current of 0.01 C mA in the potential range from 0.3 to 3.0 V vs. Li/Li⁺ at 25° C. The amount of electricity of anodic current was 1540 mAh g⁻¹ to 3.0 V vs. Li/Li⁺ corresponding to x=5.3 per chemical formula expressed as NiOOH.Liₓ for Li-contained nickel oxyhydroxide. In addition, it was found out that the discharge capacity showed large capacity of 1000 mAh g⁻¹. The electrochemical potential behavior of the electrode of Example 6 is shown in FIG. 4. Since the average discharge potential was less noble than that of Comparative example 1, Li-contained nickel oxyhydroxide of the present invention also is to be used not only as positive active material but also as negative active material for nonaqueous electrochemical cell.

### Example 7˜11

### Example 7

The electrode of Example 7 was obtained in the same manner as the case of Example 1 except that the solution S2 was prepared by using 1-methoxybutane as a solvent and naphthalene as a polycyclic aromatic compound for the solution S.

### Example 8

The electrode of Example 8 was obtained in the same manner as the case of Example 1 except that the solution S3 was prepared by using 1-methoxybutane as a solvent for the solution S and anthracene as a polycyclic aromatic compound.

### Example 9

The electrode of Example 9 was obtained in the same manner as the case of Example 1 except that the solution S4 was prepared by using 1-methoxybutane as a solvent for the solution S and phenanthrene as a polycyclic aromatic compound.

### Example 10

The electrode of Example 10 was obtained in the same manner as the case of Example 1 except that the solution S5 was prepared by using 1-methoxypropane as a solvent for the solution S and naphthalene as a polycyclic aromatic compound.

### Example 11

The electrode of Example 11 was obtained in the same manner as the case of Example 1 except that the solution S6 was prepared by using 1-methoxypropane as a solvent for the solution S and anthracene as a polycyclic aromatic compound.

### Example 12

The electrode of Example 12 was obtained in the same manner as the case of Example 1 except that the solution S7 was prepared by using 1-methoxypropane as a solvent for the solution S and phenanthrene as a polycyclic aromatic compound.

The electrochemical potential behavior for each electrode of Example 7 to 12 was measured using glass cell with 3 electrodes in the same manner as the case of Example 1 by passing cathodic current (discharging) at constant current of 0.01 C mA to 1.5 V vs. Li/Li⁺ after passing anodic current (charging) at constant current of 0.01 C mA to 4.2 V vs. Li/Li⁺ at 25° C. Each electrode was then measured by passing cathodic current at constant current of 0.05 C mA to 1.5 V vs. Li/Li⁺ after passing anode current at constant current of 0.05 C mA to 4.2 V vs. Li/Li⁺ at 25° C. The retention value (%) of discharge capacity at constant current of 0.05 C mA to discharge capacity at constant current of 0.01 C mA was defined as high rate discharge. In addition, Example 1 was also measured in the same manner. The obtained values of high rate discharge performance are summarized in Table 3.

TABLE 3

| | | | | The amount | | |
|---|---|---|---|---|---|---|
| | | | | of electricity | Discharge | |
| | | | Polycyclic | charged at | capacity at | High rate |
| | | | aromatic | 1st cycle | 1st cycle | discharge |
| | Solution S | Solvent | compounds | mAh g⁻¹ | mAh g⁻¹ | performance % |
| Example 1 | S1 | Diethyl ether | Naphthalene | 282 | 201 | 93 |
| Example 7 | S2 | 1-Methoxybutane | Naphthalene | 280 | 200 | 92 |
| Example 8 | S3 | 1-Methoxybutane | Anthracene | 281 | 200 | 91 |
| Example 9 | S4 | 1-Methoxybutane | Phenanthrene | 283 | 203 | 90 |
| Example 10 | S5 | 1-Methoxypropane | Naphthalene | 281 | 201 | 92 |
| Example 11 | S6 | 1-Methoxypropane | Anthracene | 278 | 198 | 90 |
| Example 12 | S7 | 1-Methoxypropane | Phenanthrene | 284 | 204 | 87 |

In the case of using different kind of solvents and polycyclic aromatic compounds for the solution S, it was found out that Li-contained nickel-oxyhydroxide shows almost the same electrochemical behavior and the no side reaction of extraction H from NiOOH was occurred in Table 3.

### Examples 13˜20

### Example 13

The electrode of Example 13 was obtained in the same manner as the case of Example 1 except cobalt-substituted nickel oxyhydroxide (Ni_{0.999}Co_{0.001}OOH) powder for nickel oxyhydroxide (NiOOH) powder, wherein the content of cobalt is 0.1 mol % to the total mole concentration of nickel and cobalt.

### Example 14

The electrode of Example 14 was obtained in the same manner as the case of Example 1 except cobalt-substituted nickel oxyhydroxide (Ni_{0.998}Co_{0.002}OOH) powder for nickel oxyhydroxide (NiOOH) powder, wherein the content of cobalt is 0.2 mol % to the total mole concentration of nickel and cobalt.

### Example 15

The electrode of Example 15 was obtained in the same manner as the case of Example 1 except cobalt-substituted nickel oxyhydroxide (Ni_{0.99}Co_{0.01}OOH) powder for nickel oxyhydroxide (NiOOH) powder, wherein the content of cobalt is 1.0 mol % to the total mole concentration of nickel and cobalt.

### Example 16

The electrode of Example 16 was obtained in the same manner as the case of Example 1 except cobalt-substituted nickel oxyhydroxide (Ni_{0.95}Co_{0.05}OOH) powder for nickel oxyhydroxide (NiOOH) powder, wherein the content of cobalt is 5 mol % to the total mole concentration of nickel and cobalt.

### Example 17

The electrode of Example 17 was obtained in the same manner as the case of Example 1 except cobalt-substituted nickel oxyhydroxide (Ni_{0.8}Co_{0.2}OOH) powder for nickel oxyhydroxide (NiOOH) powder, wherein the content of cobalt is 20 mol % to the total mole concentration of nickel and cobalt.

### Example 18

The electrode of Example 18 was obtained in the same manner as the case of Example 1 except cobalt-substituted nickel oxyhydroxide (Ni_{0.76}Co_{0.24}OOH) powder for nickel oxyhydroxide (NiOOH) powder, wherein the content of cobalt is 24 mol % to the total mole concentration of nickel and cobalt.

### Example 19

The electrode of Example 19 was obtained in the same manner as the case of Example 1 except cobalt-substituted nickel oxyhydroxide (Ni_{0.75}Co_{0.25}OOH) powder for nickel oxyhydroxide (NiOOH) powder, wherein the content of cobalt is 25 mol % to the total mole concentration of nickel and cobalt.

### Example 20

The electrode of Example 20 was obtained in the same manner as the case of Example 1 except cobalt-substituted nickel oxyhydroxide (Ni_{0.57}Co_{0.43}OOH) powder for nickel oxyhydroxide (NiOOH) powder, wherein the content of cobalt is 43 mol % to the total mole concentration of nickel and cobalt.

The electrochemical potential behavior for the each electrode of Example 13 to 20 was tested by passing anodic current and cathodic current at the same condition of the case of Example 1. The electrochemical behavior of the electrode of Example 17 is shown in FIG. 5 as a representative example.

The potential of the electrode is shifted toward more noble potential gradually from 1.7 V vs. Li/Li⁺ to 4.2 V vs. Li/Li⁺ as shown in FIG. 5 with the passage of anodic current. The amount of electricity was 317 mAh g⁻¹ per mass unit of Li-contained nickel oxyhydroxide after passing anodic current. The potential of the electrode was shifted toward less noble potential gradually from 3.9 V vs. Li/Li⁺ to 1.5 V vs. Li/Li⁺ with the passage of cathodic current at same current. The amount of electricity was 232 mAh g⁻¹ per mass unit of Li-contained nickel oxyhydroxide by passing cathodic current. The amount of electricity was 317 mAh g⁻¹ means that the value of x of general chemical formula of Ni₁₋ₐCoₐOOH.Liₓ was 1.09 after insertion of Li into nickel oxyhydroxide.

The electricity charged obtained by passing anodic current and the x value of inserted lithium for Example 13 to 20 are summarized in Table 4. In addition, the result of Example 1 of which sample was not replaced by cobalt, is also shown in Table 4 for comparison.

TABLE 4

| | The amount of | Electricity charged at | The x value of |
|---|---|---|---|
| | cobalt substitution | 1st cycle | inserted |
| | mol % | mAh g⁻¹ | lithium |
| Example 1 | 0 | 282 | 0.97 |
| Example 13 | 0.1 | 293 | 1.00 |
| Example 14 | 0.2 | 302 | 1.03 |
| Example 15 | 1 | 307 | 1.05 |
| Example 16 | 5 | 312 | 1.07 |
| Example 17 | 20 | 317 | 1.09 |
| Example 18 | 24 | 319 | 1.09 |
| Example 19 | 34 | 289 | 0.99 |
| Example 20 | 43 | 288 | 0.98 |

From the test result, the replacement of cobalt for nickel of Li-contained nickel-oxyhydroxide increases the capacity and the value is especially increased by cobalt substitution in the range of 0.2 to 24 mol % in Table 4.

### Example 21˜23

### Example 21

A nonaqueous electrolyte rechargeable cell (NiOOH.Li/C system) was prepared by using Li-contained nickel oxyhydroxide used for Example 1 as a positive active material and graphite as a negative active material. The charge-discharge reaction of this cell is considered to be the following equation (1). Right direction is charge reaction and left direction is discharge reaction.
NiOOH.Li+6C=NiOOH+LiC₆ (1)

The positive electrode with nominal capacity of 13 mAh was produced using Li-contained nickel oxyhydroxide powder coated on foamed Ni plaque with the porosity of 85% and the size of 10 mm W×20 mm L×150 μm T used for Example 1. The paste was prepared by mixing 80 mass % graphite flake with average particle diameter 10 μm and 20 mass % PVDF in NMP. This paste was then coated on Cu foil with 15 μm thickness and dried at 150° C. for evaporation of NMP, followed by pressing with roll-press machine. The negative electrode with nominal capacity of 18 mAh was prepared by slitter for the size of 10 mmW×20 mmL×100 μmT. The NiOOH.Li/C system 2-electrode-type nonaqueous electrolyte rechargeable cell with nominal capacity of 13 mAh of Example 21 was produced using the above positive and negative electrodes with the mixture electrolyte of 1 mol dm⁻³ LiClO₄ containing ethylene carbonate (EC) and ethyl methyl carbonate (EMC) (1:1 in the volume ratio).

The charge-discharge test of this cell was carried out at constant current of 0.5 mA at 25° C. The discharge characteristic is shown in FIG. 6. The discharge curve changes monotonously from 3.2 V to 1.4 V, and its discharge capacity was 11 mAh as shown in FIG. 6. This value is corresponded to 200 mAh g⁻¹ per the positive active material of which value is high and really practical for positive active material of the commercial based cell. In addition, it was found out that it was able to be reversible for charge-discharge cycling resulting in the establishment of new rechargeable cell.

### Example 22

A nonaqueous electrolyte rechargeable cell (V₂O₅/NiOOH.Li system) was prepared by using vanadium pentoxide (V₂O₅) as a positive active material and Li-contained nickel oxyhydroxide as a negative active material. The charge-discharge reaction of this cell is considered to be following equation (2). Right direction is charge reaction and left direction is discharge reaction
V₂O₅+2NiOOH.Li=Li₂V₂O₅+2NiOOH (2)

The positive electrode was prepared as follows. First, the past was prepared by mixing 75 mass % well-known V₂O₅ powder with average particle diameter 80 nm, 5 mass % AB, and 20 mass % PVDF in NMP for positive electrode. The paste was then coated on Al foil with 20 μm thickness and dried at 150° C. for evaporation of NMP followed by pressing with roll-press machine, and finally slit into the positive electrode of 10 mmW×20 mmnL×100 μmT with nominal capacity of 20 mAh. The negative electrode with nominal capacity of 13 mAh was prepared by coating Li-contained nickel oxyhydroxide on foamed Ni plaque with the porosity of 85% and 10 mmW×20 mmL×150 μmT used in Example 6.

The V₂O₅/NiOOH.Li system 2-electrode-type nonaqueous electrolyte rechargeable cell of Example 22 was produced using above positive and negative electrodes with the electrolyte according to the same manner as the case of Example 21.

The charge-discharge test of this cell was carried out at constant current of 0.5 mA at 25° C. The discharge characteristic is shown in FIG. 7. The discharge curve changes monotonously from 3.5 V to 0 V, and its discharge capacity was 14 mAh as shown in FIG. 7. The value was corresponded to 251 mAh g⁻¹ per mass unit of Li-contained nickel-oxyhydroxide of Example 22 resulting in the sufficiently functional negative active material for Li-ion cell. It was also found out that it was able to be reversible for charge-discharge cycling. Thus new rechargeable cell was established using this new negative electrode material.

### Example 23

A capacitor of Example 23 was prepared by the same manner as the case of Example 21 expect the use of Li-contained nickel oxyhydroxide as negative active material with nominal capacity of 3.6 mAh and active carbon as a negative active material with nominal capacity of 2.6 mAh. The charge-discharge test of this capacitor was carried out on the same condition of the case of Example 21. The electrochemical characteristic is shown in FIG. 8. It was found to be reversible for charge-discharge cycle as shown in FIG. 8. Thus, Li-contained nickel oxyhydroxide of the present invention is to be used as an active material for capacitor.

1. A manufacturing process of Li-contained nickel oxyhydroxide characterized by a lithium absorption process with contact between nickel oxyhydroxide and solution obtained by dissolving metallic Li and polycyclic aromatic compound in a solvent.

2. A manufacturing process of Li-contained nickel oxyhydroxide according to claim 1, wherein the amount of lithium absorption x is in the range of 0.5≦x≦2 mol to the 1 mol of nickel oxyhydroxide.

3. A manufacturing process of Li-contained nickel oxyhydroxide according to claim 1, wherein the half width of the peak appeared at around 2 θ=18.8±0.5° of X-ray diffraction patterns obtained by the measurement of the Li-contained nickel oxyhydroxide using CuKα radiation is equal to or more than 1.0°.

4. A manufacturing process of Li-contained nickel oxyhydroxide according to claim 1, wherein a part of nickel of the Li-contained nickel oxyhydroxide is replaced by cobalt and the content of cobalt is in the range from 0.2 to 24 mol % to the total mole concentration of nickel and cobalt in the Li-contained nickel oxyhydroxide.

5. A manufacturing process of Li-contained nickel oxyhydroxide according to claim 1, wherein one of the polycyclic aromatic compounds is selected from naphthalene, phenanthrene, and anthracene.

6. A manufacturing process of nonaqueous electrolyte electrochemical cell characterized by using an electrode with Li-contained nickel oxyhydroxide obtained by the process according to claim 1.

7. A manufacturing process of the nonaqueous electrolyte electrochemical cell according to claim 6 using an electrode with the Li-contained nickel oxyhydroxide obtained by the process according to claim 2.

8. A manufacturing process of the nonaqueous electrolyte electrochemical cell according to claim 6 using an electrode with the Li-contained nickel oxyhydroxide obtained by the process according to claim 3.

9. A manufacturing process of the nonaqueous electrolyte electrochemical cell according to claim 6 using an electrode with the Li-contained nickel oxyhydroxide obtained by the process according to claim 4.

10. A manufacturing process of the nonaqueous electrolyte electrochemical cell according to claim 6 using an electrode with the Li-contained nickel oxyhydroxide obtained by the process according to claim 5.
